(19) United States
(12) Patent Application Publication
(10) Pub. No.: US 2006/0190300 A1
(43) Pub. Date: Aug. 24, 2006

(54) Post payment provider agreement process

(75) Inventor: Vincent Drucker, Dallas, TX (US)

Correspondence Address: HOWISON & ARNOTT, L.L.P, P.O. BOX 741715, DALLAS, TX, 75374-1715, US

(73) Assignee: FairPay Solutions, Inc.

(21) Appl. No.: 11/406,966

(22) Filed: Apr. 19, 2006

Related U.S. Application Data
(63) Continuation-in-part of application No. 11/124,938, filed on May 9, 2005.
(60) Provisional application No. 60/572,433, filed on May 19, 2004.

(51) Int. Cl. G06Q 10/00

(52) U.S. Cl. 705/2

(57) ABSTRACT

A method and business technique for reviewing medical service provider bills, recalculating and providing payment recommendation to a paying party for the bills. The method includes analyzing medical bills and determining erroneous and inappropriate charges on bills. The method provides a payment recommendation using multiple databases and sophisticated mathematical modeling that includes one or more of the following: a medical service provider's actual cost of delivering the medical services provided; the average profit-margin of that provider, an average profit margin of comparable medical providers in an area, other industry-specific profit-margin benchmarks; an average acceptable payment by medical service providers in the area for comparable services; payment rates negotiated by large health insurers and managed care organizations; and other industry benchmarks for reasonable payment for comparable services.

### RELATED APPLICATION

This application is a Continuation-in-Part Utility Application of U.S. patent application Ser. No. 11/124,938, filed on May 9, 2005, which is a Utility Application of Provisional Application Ser. No. 60/572,433, filed on May 19, 2004, of which all are incorporated herein by reference in their entirety.

### BACKGROUND OF THE INVENTION

Embodiments of the present invention relate in general to reviewing medical related bills. Embodiments of the present invention relate more particularly to a method and business technique for reviewing medical service provider bills, re-calculating the same and providing a payment recommendation for the bills. Embodiments of the present invention further relate to a process for handling the post payment of medical service provider bills.

### Description of Related Art

In the United States today, health care charges are skyrocketing. The days of a single family practice doctor or nurse typing medical bills for services rendered are gone. Even small offices and clinics have all changed to computer billing. In large clinics and hospitals, the billing departments are virtually (if not entirely) separate from the actual process of doctors and nurses providing medical care. The people working in billing departments may have no medical backgrounds and are mainly concerned with generating bills for medical services and collecting money for the same. The bills sent out by the billing department can be complicated. Often the billing department personnel cannot provide a proper explanation for the charges since the procedure codes used in the bills are created by others (e.g. the medical records department or medical staff where the services are rendered) and the charges for the services and items provided are generated from multiple sources (check-off sheets, swiped bar codes on supplies, pharmacy dispensing records, automated rules, etc.). The medical bills are not designed for a patient to understand and there is no system set up to make it convenient for a patient to ask questions, get information or even have someone adjust errors in a medical bill.

Most hospitals and other health care facilities, such as ambulatory surgical centers (ASCs), charge patients for medical services and supplies when they are ordered, not when they are received by the patient. If a doctor's order changes and the services/or supplies are not used by the patient, the charges may remain on the bill in error. Many hospitals and other facilities charge a standard list of services and items based on the procedure performed (e.g. a simple emergency visit), a daily rate (e.g. what is being used in one day in an intensive care unit), or some other similar unit of service regardless of what items or services were actually provided. (commonly called procedure-based charging, per-diem based charging, surgery cart-based charging, etc.) Similarly, if the patient is discharged from a hospital sooner than anticipated, the patient may be billed for services they never actually received. Many facilities bill the same charges multiple times: one time in an all-inclusive facility charge (ICU, recovery, operating room, etc.); a second time when some of the items are charged for separately, such as supplies and medication and equipment, and a third time when items previously charged in the all-inclusive facility charges and itemized charges may, again, be charged as part of surgical trays, packs and other pre-made packages. Other factors that contribute to improper billing are human errors (e.g., keystroke errors), complicated billing systems and duplicate billings caused by different departments entering the same medical procedures, items that were used being charged to the wrong patient, etc.

Since the advent of Medicare, in the 1960ies during the Johnson presidency, there have been a series of initiatives by governmental and other payers to control the rising costs of medical care and to counter various “creative” charging practices by facilities and medical providers. The Federal Government and State Governments have primarily tried to control costs through various initiatives that control the payments for services rendered and counter various “creative” charging practices and, to a lesser extent, ration care by -not paying for treatments that they consider to be inappropriate or experimental. Insurance companies and other group health payers have adopted a multi-faceted strategy known as managed care. In addition to controlling the prices they pay, under managed care insurance companies use other “managed care” methods including sets of rules that specify, for a given injury, the type of treatments and the quantity of such treatments that the payor will pay.

The Federal Government has adopted various payment protocols that today pay almost entirely according to set schedule of fees for the specific services rendered by different types of providers and facilities. The State Governments, when they regulate the appropriate payment for medical services for work-injury and/or auto accident-injury victims, also largely use fee schedules. The very large insurance companies who are providing health insurance largely to employer-sponsored groups, also have adopted fee schedules. These are usually variants of the payment methodology researched and developed by the Federal Government.

The Centers for Medicare and Medicaid Services (CMS) is the Federal agency responsible for the operation and oversight of federally-funded Medicare and Medicaid medical insurance programs. These medical insurance programs handle the medical claims submitted by health care providers, such as doctors and hospitals. The medical insurance programs then reimburse claims that are valid. To stop intentional and unintentional over billing, Medicare has implemented various rules and controls that place an enormous burden upon health care providers to code and bill in accordance with Medicare's stringent and ever-changing rules.

Preferred Provider Organizations (PPOs) are often used by payers which cover smaller numbers of employees and groups. PPOs negotiate discount payment agreements with providers, in return for promising to channel more patients to the provider. PPO agreements typically specify a discount from billed charges or “Usual, Customary & Reasonable” charges.

There is a large and growing number of patients whose payments are not subject to the fee schedule rates mandated by Federal and State governmental authorities nor are they able to access the reduced fees negotiated by large insurance companies.

There has been aggressive pricing and manipulation of charges by providers that disadvantages these patients who are outside one of these large payer systems. While the large payor systems pay roughly 66% of professional's “Usual, Customary and Reasonable (UCR) charges and around 37% of the UCR charges by facilities, those patients who are outside these systems are being asked to pay 100% of the providers' and facilities' charges.

### SUMMARY OF THE INVENTION

One aspect of embodiments of the present invention provides a method for finalizing an agreement for payment of medical services. The method includes reviewing, repricing and establishing a repriced bill for a bill from a medical service provider for services performed on a patient. Once the repriced bill is determined, the medical service provider may be paid the repriced bill amount. After a predetermined period of time and during a block of time after the predetermined period of time, the medical service provider is contacted to determine whether the medical service provider will accept the repriced payment as full payment for the medical services provided to the patient. If the medical service provider agrees to -accept the repriced amount as full pay, then a zero balance confirmation letter is sent to the medical service provider for signature. The zero balance confirmation letter confirms that no additional payment is required for the medical services provided to the patient. If the medical service provider does not accept the paid repriced bill amount as complete payment for the medical service bill, then a negotiated settlement amount is determined. The negotiated settlement amount may be based on specifically identified reimbursement data points related to one or more medical bill line items. Such reimbursement data points were determined during the repricing of the medical service provider's bill.

In another aspect of an embodiment of the present invention, a method of establishing a payment amount for a medical service provider's bill for medical services rendered to a patient is provided. The method comprises receiving a medical service provider's bill and performing a front-end negotiation process in order to reprice the bill. The repriced bill is then paid per the negotiated settlement. If the front-end negotiation process is not successful, or a payer opts to not utilize this process, then a back-end negotiation process applies to the medical service provider's bill. The back-end negotiation process comprises contact with the medical service provider and settling that the medical service provider's bill is paid in full. If the medical service provider agrees that the bill is already paid in full, then the medical service provider is requested to sign a zero balance confirmation letter. If the medical service provider does not agree that the medical service bill is paid in full then the repriced bill is negotiated. If the medical service provider refuses to negotiate the repriced bill, then a period of time is allowed to pass and then the medical service provider is contacted again to determine if they are interested in negotiating the bill. After the bill is negotiated, then a settlement letter is provided to, signed and received from the medical service provider prior to the negotiated bill being paid.

As this is only a summary of aspects of embodiments of the present invention, further applicability will become apparent from a review of the detailed description and accompanying drawings. It should be understood that the description and examples, while indicating at least one preferred embodiment of the present invention, are not intended to limit the scope of the invention. Various changes and modifications within the scope and spirit of the invention will become apparent to those skilled in the art.

### BRIEF DESCRIPTION OF THE DRAWINGS

For a more complete understanding of the present invention, reference is made to the following detailed description taken in conjunction with the accompanying drawings, wherein:

FIG. 1 is a block diagram that shows pertinent -details of an exemplary Medical Analysis and Review Services method, in which the present invention can be implemented;

FIG. 2 is a flow diagram of a method for reviewing medical bills in accordance with principles of the present invention; and

FIGS. 3A-3H provide a flow diagram of an exemplary front-end and back-end process according to an embodiment of the present invention.

### DETAILED DESCRIPTION OF THE EXEMPLARY EMBODIMENTS OF THE INVENTION

An exemplary embodiment of the invention, referred to as a Medical Analysis And Review Service (MAARS), forecasts future and present day medical service provider costs based on past, recent and historical medical cost information. Various techniques can be utilized to forecast future and present day costs including mathematical algorithms that have never before been applied to or used in medical cost estimations.

One of the most common issues facing the Medical Service Providers (MSP's) and the entities responsible for reimbursing the MSP's is the issue of what amount is an appropriate amount to be charged by the MSP's to the reimbursing parties. An exemplary MAARS method provides an objective process for assuring that the bill for medical services, supplies or medications charged by MSP's are paid reasonably. An embodiment of the MAARS method utilizes multivariate time series analysis based upon:

1. Legal and regulatory findings to date -in the applicable jurisdiction;

2. Cost of providing the service for comparable providers in a particular geographic region;

3. The average reimbursement being paid by all payors to medical service providers in a particular geographic region for comparable services;

4. Reasonable charges for the actual and appropriate services provided in a particular geographic region;

5. Cost to that provider for rendering the service;

6. Average profit margin for that provider; and

7. Average profit margin for comparable providers in the area.

An exemplary MAARS method is state-specific pursuant to each state's legislative records, published guidelines, rules, administrative notices and each state's case laws. In addition, the exemplary MAARS method utilizes applicable federal legislative records, published records, published guidelines, rules, administrative notices and federal case laws. Furthermore, the exemplary MAARS method uses a plurality of databases and mathematical algorithms that have never before been applied to or used in medical pricing estimations to determine a reasonable amount to pay for medical bills.

MSP's generally use several types of procedure codes. The procedure codes specify the medical procedures ordered. The first type of code is called a Common Procedural Terminology (CPT) code, which was developed by the American Medical Association (AMA). The second type of CPT code is a Health Care Procedural Coding System (HCPCS), which was developed by Health Care Financing Administration (HCFA) to address issues with the CPT codes as they relate to medical billing. More specifically, each CPT code indicates a set of related medical procedures that can be ordered.- Two other sets of codes are from the International Classification of Diseases (ICD). The third type of code used in the United States is ICD procedure code, which also indicate the procedures ordered. The fourth type of code is ICD diagnosis codes that specify and classify the injury or disease or illness of the patient. CPT and ICD codes can represent a simple procedure or a more complex procedure.

In many instances, medical bills from MSP's include overcharges. An overcharge is a charge over the accepted charge for the medical treatment or for other additional medical issues not specifically approved by the reimbursing or paying party. There are several ways by which MSP's overcharge patients for medical services provided. According to an exemplary embodiment, a patient can be mistakenly billed for medical services that were never provided to the patient. Therefore, it is extremely important to request all medical records, pharmaceutical records and itemized bills from the MSP's. As an example, the medical records may show results of six blood tests while the patient is being charged for nine blood tests. Another frequent error is a duplicate bill in which the patient is billed twice for a service rendered only once.

A medical bill may include phantom charges by the MSP's. More specifically, some MSP's computer software may automatically bill for a variety of items and services ordinarily associated with a particular service regardless of whether the services or items were actually used on that patient. As an example, if the patient is billed for a childbirth, there should be no charges for sedation unless the patient actually received sedative drugs because it is not a normal medical practice to give a patient, who is birthing a child, sedatives.

Often times, MSP's overcharge for the quantity of items provided. For example a common error occurs with respect to intravenous (IV) solutions that are administered to the patient on the day of admissions to the MSP (e.g., a hospital). The hospital computer normally bills the patient for a full day's worth of IV solutions. However, if the patient was admitted to the hospital late in the day, the patient may receive only a few hours worth of IV solutions.

Proper billing procedures require MSP's to “bundle” related charges for a particular medical procedure. For example, the charge for removing an appendix will include the operating room, operating-utensils and all other goods, services and medications normally related to this operation. “Unbundling” occurs when the MSP's separate some of the charges that should be included in the “global” bundle charge for the operation, thus, duplicating some of the charges. As an example, a bill for an appendectomy may wrongly include separate charges for the pre-operative physical, such as drawing blood, a cardiogram and interpretation of the cardiogram.

Overcharges on medical bills may also result from excessive mark-ups from MSP's. As an exemplary situation, the patient may be billed $75 for a laxative or $30 for a thermal therapy kit. In particular, drugs, supply items, or care charges are often excessively marked-up. According to yet another situation, some hospitals charge much more for comparable services than other hospitals in the same geographic region.

In some instances, medical bills from the MSP's are upcoded. More specifically, the MSP's use inappropriate CPT/ICD codes related to more complicated procedures than the procedures that were actually performed. The MSP's use CPT/ICD codes on medical bills that relate to much more elaborate procedures which would enable the MSP's to bill for larger reimbursements. In general MSP's might use more expensive CPT/ICD codes to perform a service that required a lesser expensive CPT/ICD code. Other issues that may cause inflated bills may result from overstaffing a surgical procedure, unnecessary delays caused by MSP errors which may result in longer stay, surgical delays, etc.

An exemplary MAARS method helps overcome the discrepancies found in medical bills discussed above. An exemplary MAARS method utilizes cost-based methodology by analyzing the medical bills generated by the MSP's. An exemplary MAARS method verifies that the MSP's use appropriate CPT/ICD codes, identifies potential “unbundling” errors, duplicate, incorrect and “exploded” charges, identifies items and services that were never provided, identifies excessive and/or inappropriate procedures, determines the actual cost of the medical services rendered and establishes a suggested reasonable amount of reimbursement for the medical bills, the details of which will be discussed later.

According to an exemplary MAARS method or service embodiment, services rendered by Ambulatory Surgical Centers (ASC's) may also be analyzed for proper and improper billing amounts. An ASC is a free standing surgical facility licensed as a surgical center under state laws. Since very few states regulate how ASC's charge for their services, the bill for medical services or supplies charged by ASC's can be astronomical. An exemplary MAARS method delivers an objective process for assuring that the bill for medical services or supplies charged by ASC's are analyzed and paid reasonably.

According to another exemplary embodiment of the present invention, an exemplary MAARS method also analyzes medical bills for Inpatient and Outpatient services rendered by MSP's. Inpatient medical care refers to treatment provided to an individual admitted as a bed patient in a hospital or any other medical facility where room and board charges are incurred. Outpatient medical care refers to treatment provided to an individual without having to be admitted to a hospital or any other medical facility. An exemplary MAARS method delivers an objective process for assuring that the bill for medical services or supplies charged for Hospital Inpatient and Outpatient services are analyzed and paid reasonably.

In yet another embodiment, an exemplary MAARS method is used for recalculating -and providing payment recommendations for other medical bills including, but not limited to, services by physicians, chiropractors, pharmacies, medical supplies, durable medical equipment, etc. An exemplary MAARS method also may be utilized to analyze and recalculate medical bills for services rendered by all other MSP's.

An exemplary MAARS method is used for recalculating and providing payment recommendations for medical bills originating from auto or group health insurance service and/or providers of health care services to other payers. Additionally, an exemplary MAARS method is also applied and used to quantify workers compensation related bills. In the workers compensation area, most states have fee schedules that dictate the reimbursement amount for a particular medical service procedure provided by MSP's. In general, medical bill recalculation only reduces medical service provider bills to amounts permitted under the fee schedules. However, the present fee schedules are not comprehensive. The exemplary MAARS method provides a detailed, comprehensive, and novel process for recalculating medical service provider bills to a reasonable amount where the fee schedules do not apply or the rules for applying them allow for providers to manipulate the billing to get additional payments.

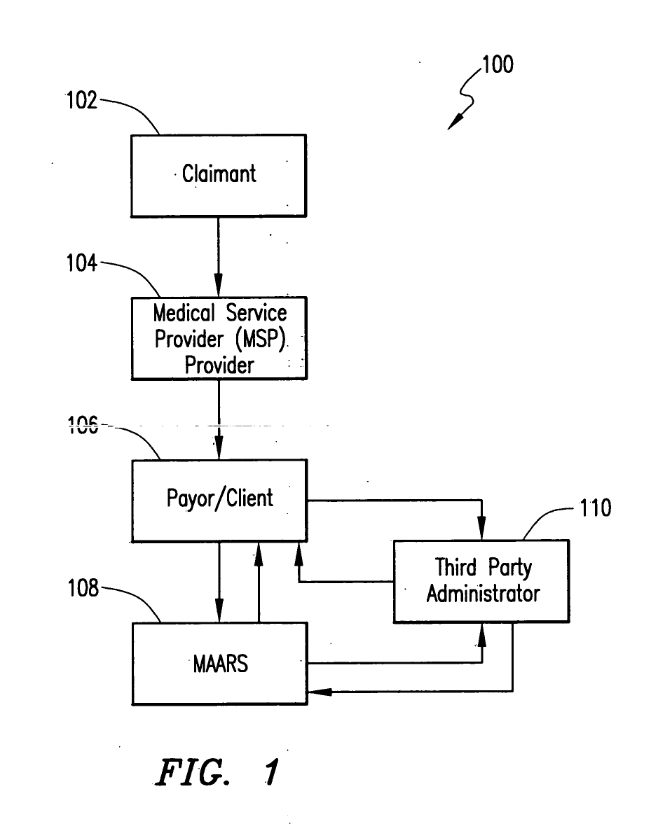

Referring now to FIG. 1, there is illustrated a block diagram that shows pertinent details of an exemplary Medical Analysis and Review Services method 100 that will be used to describe the life cycle of a medical bill in accordance with the present invention. In the block diagram, a claimant 102 refers to an individual receiving medical care. A provider 104 refers to a medical service provider rendering medical services to the individual (e.g., hospitals, doctors etc). A payor/client 106 refers to a third party entity (commercial or government) that is responsible for reimbursing the medical service provider.

In a typical workers compensation scenario, a claimant 102 suffers a job-related injury. In another exemplary scenario, the claimant 102 can be an individual suffering from an illness, an individual being injured in an auto accident or any individual otherwise requiring medical treatment. The claimant 102 then contacts a medical service provider (MSP) 104 for medical treatment. After diagnosing the injury, the MSP 104 provides necessary medical treatment to the claimant 102. The MSP 104 issues a bill to the payor/client 106 related to the medical services rendered to the claimant 102. According to an exemplary embodiment of the present invention, the payor 106 can be, for example, an insurance company. In another exemplary embodiment, the payor 106 can be a self-insured person or any other entity responsible for reimbursing the provider 104. The payor 106 reviews the medical bills submitted by the MSP's 104 and processes the bill through their standard bill review system. The payor 106 forwards the bill for specialty bill review 108, either directly or through another agent such as a Third-Party Administrator (TPA) 110.

According to an exemplary embodiment of the present invention, the medical bills are sent to an exemplary MAARS service where the bills are scanned into a MAARS system. In another exemplary embodiment, the medical bills received at a MAARS service are inspected manually. In another exemplary embodiment, the medical billing information is received electronically. After receiving the bills from the payer 106 or TPA 110, the exemplary MAARS service determines if the bills received are eligible for specialty review. A specialty review applies where the jurisdiction's laws and regulations do not define a specific payment amount for the medical services described in the MSP's itemized bill. The criteria for specialty review will vary by the type of payer and their need to have the medical bills, for which they have a payment obligation, reviewed for determining a payment recommendation. For workers' compensation payers, it may typically be bills over $1000 where the state or Federal fee schedules do not apply, or the rules for applying them allow for providers to manipulate the billing to get additional payments. For payers of first party auto medical claims, it may typically be bills over $1000 in the states where payers have a first party liability in excess of $10,000 and there are no applicable fee schedules, or the rules for applying them allow for providers to manipulate the billing to get additional payments. For payers of third party auto medical claims, it may typically be bills over $1000 for policies where they have a liability in excess of $5,000 and there are no applicable fee schedules, or the rules for applying them allow for providers to manipulate the billing to get additional payments. For group health payers, it may typically be all bills where the applicable payment formula is susceptible to MSP manipulation of the billing to get additional amounts. If the bills are not eligible for the specialty review, hey are sent back to the payor 106. However, if it is determined that the bills are eligible for specialty review, the exemplary MAARS system 108 uses a variety of rules to screen bills for inappropriate charges and a mathematical multivariate time series analysis for analyzing the remaining billed charges and for providing a recalculated payment recommendation for the remaining billed charges.

The exemplary MAARS system reviews the medical bill extensively to make sure that appropriate CPT/ICD codes have been assigned to the medical bill. In addition, the MAARS system ensures that the medical bill does not include duplicate charges, incorrect charges, “exploded” charges, “unbundling,” and other billing errors. Furthermore, the exemplary MAARS system reviews the medical bill to determine if there are any other discrepancies present on the medical bill. The exemplary MAARS system further may require that the medical bills are reviewed by a third party with medical training and/or computerized systems for any questionable charges. More specifically, the third party with medical training and/or computerized systems review the bill to inspect for charges that are either unrelated to the patient's treatment for a particular injury, for items and services that were never provided or for any unorthodox, controversial, inappropriate, or excessive procedures billed. After the bills have been thoroughly reviewed, the exemplary MAARS system determines what are the acceptable charges for the medical services rendered that should be paid, based on predetermined criteria. The MAARS system recalculates the bill and recommends a reasonable amount of payment to the MSP for the medical bill.

The exemplary MAARS method is state-specific pursuant to each state's legislative records, published guidelines, rules, administrative notices and each state's case laws. In addition, the MAARS method utilizes applicable federal legislative records, published records, published guidelines, rules, administrative notices and federal case laws. Furthermore, an exemplary MAARS method uses a plurality of national and state reference standards, that have been analyzed and mathematically modeled using multivariate time series analyses to become exemplary databases used to determine a reasonable amount of reimbursement to pay for medical bills. The reimbursement amount includes the calculated actual cost of medical services provided by the MSP's as determined by the MAARS system, along with a reasonable profit-margin for providers in the area. The exemplary MAARS system reviews the MSP's publicly filed Medicare cost reports and may use these to determine the MSP's profit margin and other statistical analyses. The exemplary MAARS system applies a statistical trending analysis to the MSP's own reported numbers to determine the MSP's average profit margins. The exemplary MAARS system then applies this analysis to similar MSPs in the same geographic area for the same services to determine what the average profit margins would be for the community. The reasonable profit margin is developed from these figures. After recalculating the bills, MAARS system generates an Explanation Of Review (EOR) for each bill that indicates a recalculated amount of payment deemed appropriate by the MAARS system for paying the MSP's. The EOR is returned back to the payor 106 either directly or through the TPA 110 or another agent of the payer.

A detailed illustration of an exemplary medical bill as issued by an MSP is included as Exhibit A to demonstrate the various portions of a medical bill that is analyzed by an exemplary MAARS system. In order to better understand the medical bill and to eliminate confusion, it is important to note that only certain portions of the bill will be discussed in detail. Referring to Exhibit A, numeral 202 provides details of the payor. According to an exemplary embodiment of the present invention, a payor refers to a third party entity (commercial or government) that is responsible for reimbursing the MSP's for medical services rendered. Section 202 includes the payor information, a bill ID number, which is used to identify various patients, a bill type, an insurance type, the date the bill was generated and the State in which the medical services were rendered.

Section 204 provides details of the claimant or a person receiving medical services. More specifically, a patient's name, employer information, the patient's social security number and the date when the patient received medical treatments are all illustrated. In addition, a claim number and a patient account number is also shown. Section 206 illustrates pertinent details of the MSP (e.g., hospitals, doctors etc.). More specifically, the information in section 206 includes the name and address of the MSP and their Tax ID. Section 208 refers to a summary of the medical services rendered to the patient along with the codes that identify the various medical services and supplies that were needed towards treating the patient.

Section 210 is an elaboration of section 208 providing a detailed itemized statement of all the procedures performed in treating the patient. The various columns of section 210 illustrate in detail the complete medical services provided by the MSP to the patient. More specifically, columns A and B illustrate the actual date on which the patient was treated along with the actual procedures that were performed to treat the patient. Column C illustrates a procedure code that represents the treatment provided to the patient. Columns D and E provide information related to the total quantity of items utilized during the treatment of the patient. The items may relate to any products that were needed for treating the patient (e.g., IV solution, drugs, supplies etc). Column G represents the total amount billed by MSP's for the patients treatment corresponding to the particular services provided in treating the patient as shown in column B.

In many cases, medical bills from the MSP's may have overcharges. Details of the various ways MSP's overcharge have been described in detail above. In several instances, before reimbursing the MSP's, a payor may send the medical bills for specialty review via the MAARS method. An exemplary MAARS method delivers an objective process for assuring that the bill for medical services or supplies charged by MSP's are reasonable or should be adjusted to a reasonable amount for payment. The MAARS method utilizes mathematical multivariate time series analysis based upon:

1. Legal and regulatory findings to date;

2. Cost of providing the service for comparable providers in a particular geographic region;

3. The average reimbursement being paid by all payers to medical service providers in a particular geographic region for comparable services;

4. Reasonable charges for the actual and appropriate services provided in a particular geographic region;

5. Cost to that provider for rendering the service;

6. Average profit margin for that provider; and

7. Average profit margin for comparable providers in the area.

An exemplary MAARS method is state-specific pursuant to each state's legislative records, published guidelines, rules, administrative notices and each state's case laws. In addition, a MAARS method utilizes applicable federal legislative records, published records, published guidelines, rules, administrative notices and federal case laws. Furthermore, the MAARS method uses a plurality of exclusive databases and mathematical algorithms that have never before been applied to or used in medical pricing estimations to determine a reasonable amount to pay for medical bills. MAARS method reviews the medical bills and provides payment recommendation for the bills as illustrated in column H of Exhibit A. Column I illustrates the recalculated amount recommended by the MAARS method for paying the MSP's. Moving now to the bottom of page 3 of the medical bill, reference numeral 212 represents the total amount billed by the MSP's for treating the patient. However, after the specialty review by the MAARS method, the recalculated and suggested amount due to the MSP's is represented by reference numeral 214. The amount represented by reference numeral 214 (as recommended by the MAARS method) includes the cost of the services to the MSP plus a reasonable mark-up (profit) for services provided by the MSP's.

According to an exemplary embodiment of the MAARS method, the method utilizes various mathematical multivariate structural time series models and applies Kalman filters where appropriate. The mathematical multivariate structural time series models are enormously powerful tools which open the way to handling a wide range of data. A strong feature of time series models used in conjunction with state-space models is the usage of an algorithm for filtering, smoothing and predicting. A state-space model is a two-layer model. An external layer involves an observed process y. This process is assumed to follow a measurement equation:
y₁=Zₜαₜ+dₜ+εₜ

For each t, yₜ is a n-vector. The n*m matrix Zₜ is a matrix of regressors, while αₜ is the regression coefficient. The vectors εₜ are independent multi-normals with zero mean and covariance Hₜ.

The internal layer involves the unobserved process α. The process is assumed to follow the transition equation:
αₜ=Tₜαₜ+cₜ+Rₜnₜ

Here Tₜ is an m*n matrix, Rₜ is an m*q matrix and the components of white noise nₜ have a multi-normal distribution with zero mean and covariance matrix Qₜ. The process is initiated with a random vector αₒ, which has a mean of aₒ and a covariance matrix of Pₒ.

The elements Zₜ, dₜ, Hₜ, Tₜ, cₜ, Rₜ, and Qₜ are referred to as the system matrices. If the system matrices do not change in time the system is said to be time-invariant or time homogeneous. The system is also stationary for a specific selection of aₒ and Pₒ.

Once the data has been put in state space form, the Kalman filter may be applied which in turn leads to algorithms for prediction and smoothing. The Kalman filter also opens the way to a maximum likelihood estimation of unknown parameters in a model. This is achieved via prediction error decomposition. Thus, a Kalman filter can be used to access and predict cost of medical services based on acceptable data associated with such services or similar services.

The Kalman filter is a recursive procedure for computing an optimal estimator of a state vector at time t, based on information available at time t. In certain engineering applications, the Kalman filter is important due to on-line estimations. The current value of a state vector is of prime interest (for example, the vector may represent the coordinates of escalating charges from the medical service provider) and the Kalman filter enables the estimate of the state vector to be continually updated as new observations become available.

Another reason for the importance of Kalman filter is that when disturbances and initial state vectors are normally distributed, the Kalman filter enables likelihood function to be calculated via what is known as a prediction error decomposition. This opens the way for the estimation of any unknown parameters in the model. The Kalman filter also provides the basis for statistical resting and model specification.

The Kalman filter is an efficient recursive algorithm for the computation of the optimal estimator aₜ and αₜ, given the information up to (and including) t. A by product is the computation of the error in estimation:
Pₜ=E[(αₜ−aₜ)(αₜ−aₜ)′]

Suppose that at time t-1, aₜ₋₁ and Pₜ₋₁ are given. The algorithm then computes the predicted values with the prediction equations:
a_{t/t-1}=Tₜaₜ₋₁+cₜ
P_{t/t-1}=TₜPₜ₋₁Tₜ′+RₜQ₁Rₜ′

The corresponding predicted yₜ is
\hat{y}=Zₜa_{t/t-1}+dₜ

The mean square error (MSE) of the innovation νₜ=yₜ−ŷₜ is
Fₜ=ZₜP_{t/t-1}Zₜ′+Hₜ

Once the new observation yₜ becomes available, the estimates of the state can be updated using the updating equations:
aₜ=a_{t/t-1}+P_{t/t-1}Zₜ′Fₜ⁻¹(yₜ−Zₜa_{t/t-1}−dₜ)
Pₜ−P_{t/t-1}−P_{t/t-1}Zₜ′Fₜ⁻¹ZₜP_{t/t-1}

As such the Kalman filter is used in a novel technique to predict costs of medical procedures based on cost information of similar medical procedures. The Kalman filter can be used to accurately estimate a cost of a new medical procedure. The Kalman filter may also be used to predict a MSP's actual cost of an unlisted or unusual medical procedure.

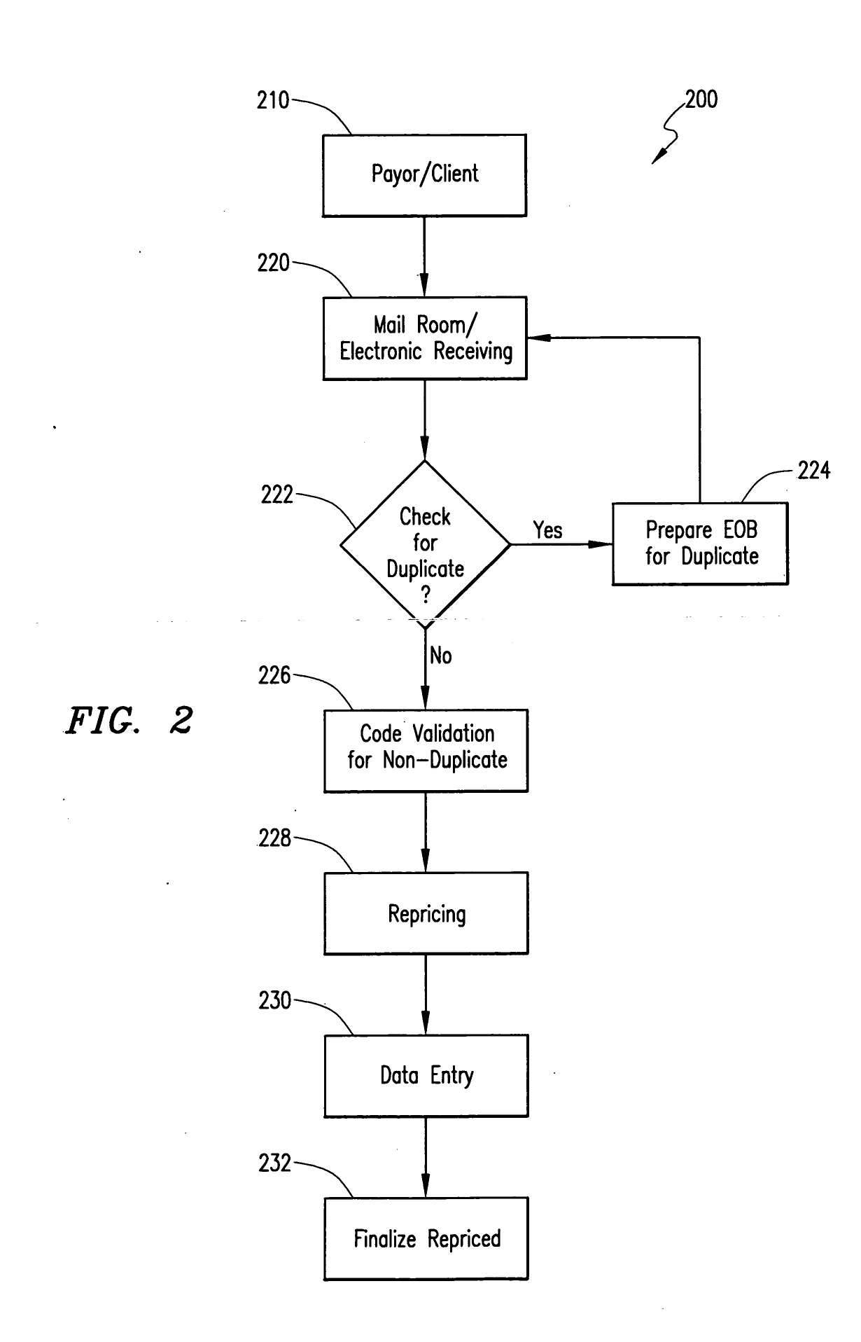

Referring now to FIG. 2, there is illustrated a flow diagram 200 of a method for reviewing medical service provider bills in accordance with principles of an exemplary MAARS method. Although the steps of the method are depicted in a particular sequence, it will be appreciated by persons of ordinary skill in the art that certain steps of the method do not necessarily follow a strict sequence but can be rearranged and/or performed simultaneously.

At step 220, medical bills from the payor/client (step 210) are received by the MAARS system 200. According to an exemplary embodiment, a single bill or a plurality of bills may be received by the MAARS system 200 at the same time. However, for purposes of simplicity, the method of reviewing the medical bills with respect to a single bill will be described.

The data from a medical bill received at the mail room or a means for electronically receiving the bill 220 is imported into a MAARS database. According to an exemplary embodiment, the medical bill is scanned into the MAARS system database by means of any ordinary scanner 220. After the bill has been scanned, certain important information related to the bill are entered into the MAARS system 200. According to an exemplary embodiment, certain important fields (e.g., client name and patient name) are entered into the exemplary MAARS system 200 by a data entry device or personnel. The bill or data received from electronic means is then sorted according to the client name and the day the bill was received. Sorting helps organize the bills according to the different clients and entities. The bill may be batched together with other bills from the same client and forwarded to at least one of the MAARS systems representatives responsible for performing the MAARS system specialty bill review.

At step 222, a MAARS system representative or electronic device reviews the bill to determine if the bill under review is a duplicate bill or if a partial or total payment has been made on the bill. If it is determined that the entire bill has been paid (step 222), the MAARS representative or electronic device software prepares an Explanation Of Review (EOR) indicating that the bill has been paid (step 224). The EOR (or the comparable data in electronic form) is sent to the mail room (or via electronic mail), which later forwards the EOR to the client. However, if it is determined at step 222 that no payment has been made on the bill in review or only a partial payment has been made, then at step 226, the MAARS representative or computer system software recalculates the bill for only portions of the bill for which no payment has been made. The MAARS representative reviews the bill extensively to determine if the bill includes inappropriate charges. MAARS representatives determine whether the diagnosis and the procedures performed were appropriate with normal standards and then verify that the bills represent appropriate CPT/ICD codes for the medical services rendered. More specifically, the MAARS system representative checks for any discrepancies in the bill that may inflate charges for the medical services provided by the MSP's.

At step 228, the MAARS system representatives or system software recalculates the medical bills using an exemplary MAARS system method. The MAARS system method utilizes multivariate time series analysis based upon:

1. Legal and regulatory findings to;

2. Cost of providing the service for comparable providers in a particular geographic region;

3. The average reimbursement being paid by all payors to medical service providers in a particular geographic region for comparable services; and

4. Reasonable charges for the actual and appropriate services provided in a particular geographic region;

5. Cost to that provider for rendering the service;

6. Average profit margin for that provider; and

7. Average profit margin for comparable providers in the area.

MAARS specialty reviews are based on a in-depth analysis of the legal and regulatory findings and case-law that are applicable to the bill because of the bill's jurisdiction and payer type (workers' compensation, auto, ERISA, state-insurance plan, etc,). These regulatory findings being continually up-dated to factor in the most current legislation, rulings and case-law. These findings are mathematically quantified to be parameters that dictate the possible appropriate methods, given the jurisdiction and payer-type, for analyzing the charges on the bill and determining the appropriate payment for the valid billed charges.

MAARS specialty reviews use multiple data bases and industry-references to calculate the fully-loaded costs (both direct and indirect costs) of providing the service, that are incurred by comparable providers in a particular geographic region. Using multiple data bases and independent methods to analyze and calculate costs, assures that these projections are highly reliable. In addition, MAARS uses multiple data bases and industry-references to calculate the profit-margin (over and above the cost of providing the service) that are enjoyed by the provider that submitted the bill and/or comparable providers in a particular geographic region. These findings become the minimum reference point for MAARS projections of the appropriate amount to pay in a specific jurisdiction and for a specific payer-type.

MAARS specialty reviews use multiple data bases and industry-references to calculate the average payment being paid by all payors to medical service providers in a particular geographic region for comparable services. The amounts that other payors actually pay, as distinguished from the amounts the medical service provider bills, serve as an indicator of the market value of those services. Using multiple data bases and independent methods to analyze and calculate this average payment amount, assures that these projections are highly reliable. These findings are a reference point for MAARS projections of the appropriate amount to pay in a specific jurisdiction and for a specific payer-type.

The MAARS system reviews the documentation supporting the MSP's itemized invoice to verify that the services, devices and goods billed were actually utilized in treating the claimant. The MAARS system also compares the supporting documentation with the itemized billing to identify any billed services incongruent with the diagnosed condition.

The MAARS method is state-specific pursuant to each state's legislative records, published guidelines, rules, administrative notices and each state's case laws. In addition, the MAARS method utilizes applicable federal legislative records, published records, published guidelines, rules, administrative notices and federal case laws. Furthermore, the MAARS method uses a plurality of proprietary databases and mathematical algorithms that have never before been applied or used in medical pricing estimations to determine a reasonable amount to pay for medical bills.

While the proprietary databases are confidential, generally they are (a) compilations and mathematical analysis of data that is area-specific and procedure-specific and (b) rules for analyzing inappropriate charges. The compilations and mathematical analysis of data include area-specific and procedure-specific data on United States MSPs' costs, costs of specific MSP's for the services, the mix of payer-sources paying different types of MSPs in every United States area, the area-specific United States profit-margins of different types of MSPs, the specific profit margins of specific MSP's, the area-specific United States mark-up (over costs) of different types of MSPs, the area-specific and procedure-specific rates paid by other major payers to United States MSPs, data on the median and other percentile charges of United States MSPs' that is area-specific and procedure-specific. The rules and hierarchical ordering of the rules for analyzing inappropriate charges are based on extensive proprietary research and analysis of rules published by United States Federal, United States state, United States and foreign medical professional organizations and publications, managed care organizations, actuarial, and other establishments with specialized medical expertise.

At step 230, the recalculated bill is entered into the MAARS system and an EOR is generated. The EOR indicates a recalculated amount of reimbursement for the medical bill. The reimbursement amount includes the actual cost of medical services provided by the MSP as determined by the MAARS system plus a reasonable mark-up. The recalculated bill along with the EOR is sent to another MAARS system representative (step 232) for a quality-assurance review to ensure that the payment for the valid charges on the medical bill has been properly recalculated before being forwarded to the client.

In another embodiment of the invention, a post payment provider agreement process is provided. The post payment provider agreement process generally takes place in the back end to aid in lowering the post payment of a medical bill, workmen's compensation bill or auto insurance related bill, which was already paid in full or in part. The payment already made was done at the recommendation from within the front end of an exemplary repricing process or MAARS system in accordance with embodiments of the present invention. An individual, an insurance company, a medical insurance company, a workman's compensation insurance company, third party payer, or other paying entity who is the payer for medical services, receives a recommendation from the front end of an exemplary bill review and negotiation method that is in accordance with an embodiment of the present invention to pay all or part of the bill. In many cases, the original bill received from a medical service provider was repriced and the repriced amount was paid. The repriced amount paid was for medical services rendered for a patient in order to compensate a medical facility for an outstanding balance due minus the deductions or reductions suggested according to the repricing method. Various third party payers may be a third party administrator, a medical insurance company or other insurance company paying on behalf of a patient. The medical service provider may be a physician, a medical facility, a hospital, an out-patient surgery center, a medical or pharmaceutical supplier, a durable medical equipment supplier, a nursing home, a supervised elderly living facility, or a home health nursing program just to name a few.

As discussed above, repricing of a bill includes looking at each line item of a medical bill for duplication of charges, the unbundling of charges, for charges that are above a geographical norm for the same or similar services, for charges that are outside of a PPO contract, for up-charging or up-coding, or other discrepancies in a service provider's bill.

Repricing of the bill and then having the repriced portion paid is done in accordance with embodiments of the present invention in order to provide the medical service provider with a reasonable payment for services provided. After payment of the repriced bill is made, a waiting period or a period of time is allowed to pass. After the period of time, the service provider is contacted to make sure that they accept the repriced payment of the bill or to determine if they would like to further negotiate the payment amount. The period of time is used so that the billing cycle of the service provider can proceed and so that when the service provider is contacted, the service provider will understand that a repriced portion of the medical bill has already been paid. As such the service provider will be able to determine whether it will accept the payment as a full payment or request renegotiation of the payment amount. In some states, the service provider may charge the patient for any unpaid amount due on the service provider's bill. As such, another reason for contacting the service provider after paying the repriced portion or the repriced amount of the bill is to deter the service provider from charging the patient directly for any unpaid charges. In most states, the worker's comp laws and rules require that a medical service provider cannot send a bill to the patient. Conversely, a rule allowing unpaid portions of a bill to be sent directly to the patient generally does not exist for patients who received medical services related to auto claims or for medical or group health claims. Thus, in embodiments of the invention it is important to contact the service provider within a period of time after a repriced medical bill is paid in order to make sure that the medical service provider agrees on the payment recommendation and repricing amount of the medical bill. If the service provider does not agree to the repriced amount, then a negotiation toward a settlement for an agreeable amount may proceed. Sometimes the negotiated settlement may be a few dollars higher than the repriced amount. Sometimes it may result in a 50% or more difference in price with a savings to the third party payer/insurance company.

It is important to understand the difference between the front-end negotiation and the back-end negotiation in embodiments of the present invention. In the front end negotiation, the medical service provider has not received any payment for the services rendered to a patient. The typical service provider may indicate during the negotiation process that they have a PPO agreement that indicates and allows a predetermined percentage discount off of the billed charges. In response thereto, a negotiator, in accordance with the method of the present invention, may indicate that the medical service provider's bill has not been audited and has not been repriced. There is a possibility of some duplicate charges, some charges that are inaccurate, or charges that are not related to this particular medical claim that should be removed from the bill or repriced. Still in the front end negotiation, the medical service provider may or may not negotiate or settle for a discounted price and agree to the discounted pricing front end.

Conversely, in the back end, a medical service provider has already received some payment for the medical services, which may make the medical service provider somewhat more willing to negotiate. Furthermore, in the back end process, the service provider's account receivable process has already begun and in some cases, since monies have already been received, the accounting department may be more willing to accept a lesser amount of payment than the initial bill amount. This may be true because in the back end negotiation the bill is probably going to be at least three or more months old and the accounts receivable department may be more willing to negotiate in order to clear their books of the particular bill. Conversely, on the front end negotiation, the bill may be a month or less old and negotiation may be somewhat less available. Thus, by contacting the service provider on the back end, the service provider's accounts receivable department may be more interested in cleaning up their receivables and getting the billings off the books as they get older. In some embodiments of the present invention, the waiting period between having the repriced bill paid and contacting the medical service provider's accounting department may go from 30 days to six or more months. Regardless, in various embodiments of the present invention, a medical service provider is contacted during a predetermined amount of time after the service provider's medical bill has been repriced and paid. The predetermined amount of time may be within a range from 30 days to seven or eight months. Preferably, the predetermined amount of time is within a time period that is less than an amount of time after which the medical service provider will contact the payer. In other words, the medical service provider should be contacted during a period of time that is after the repriced medical bill is paid, but before the medical service provider contacts the third party payer (i.e., medical insurance company or other insurance company), the patient receiving the medical services, or another payment guarantor.

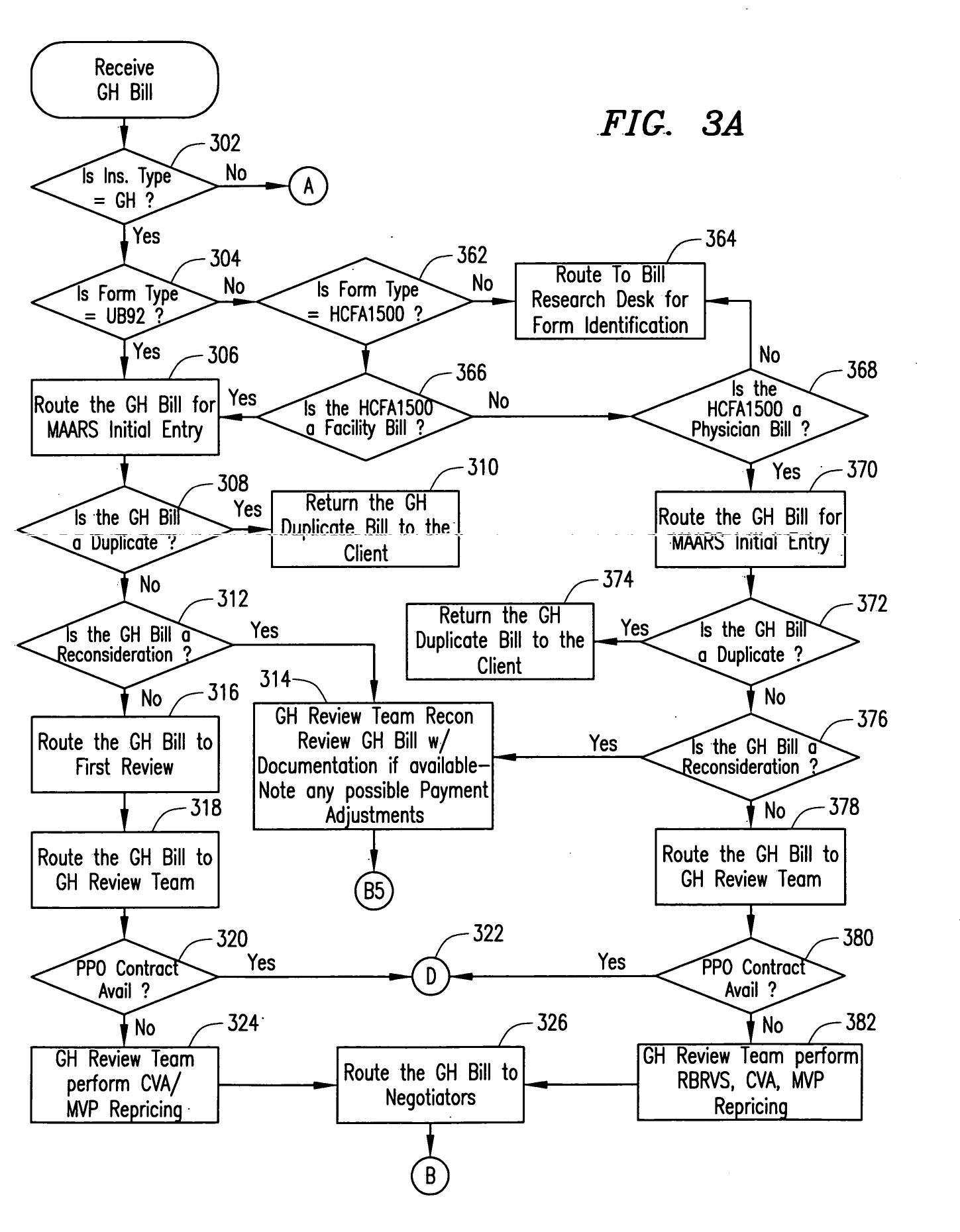

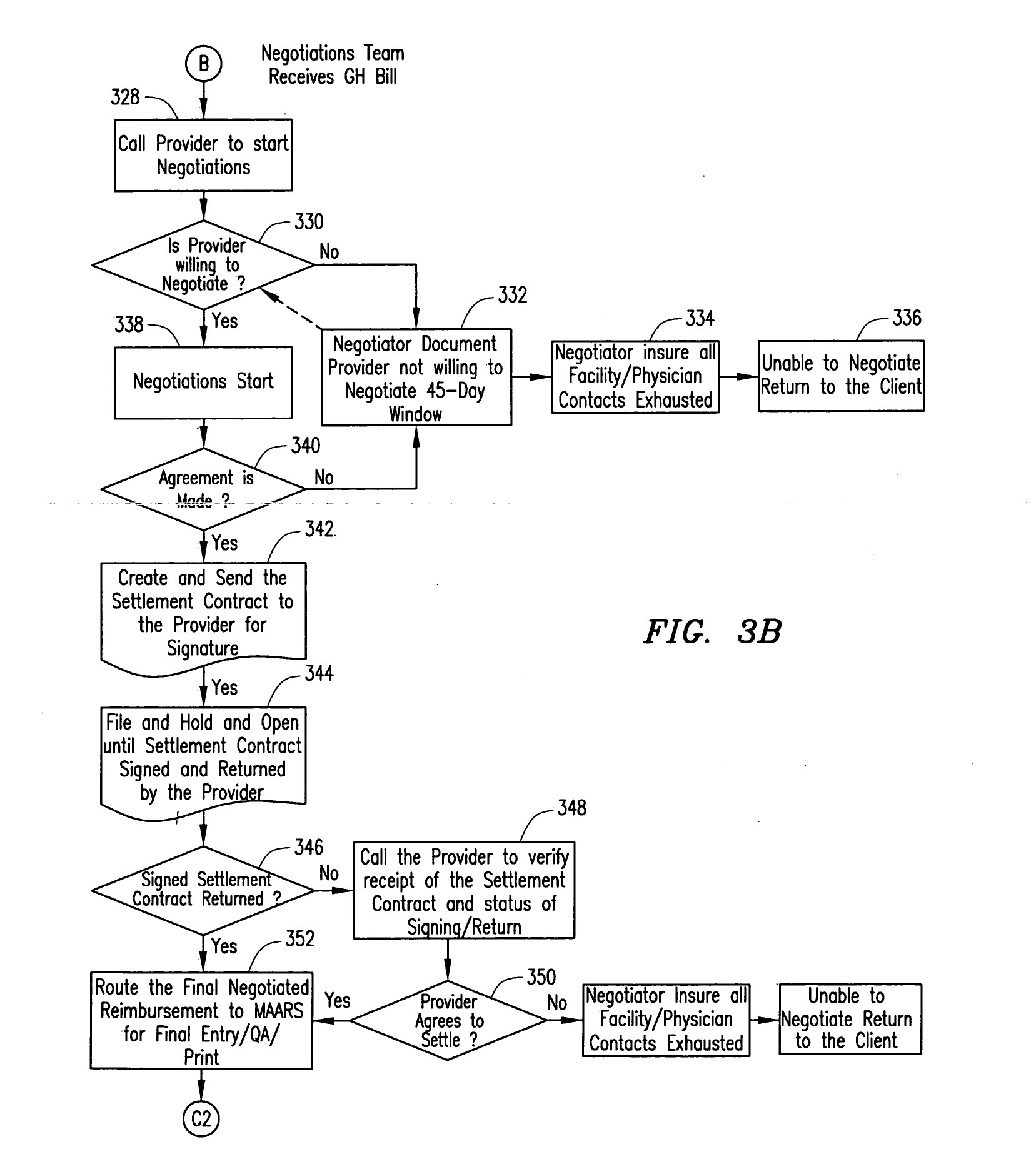

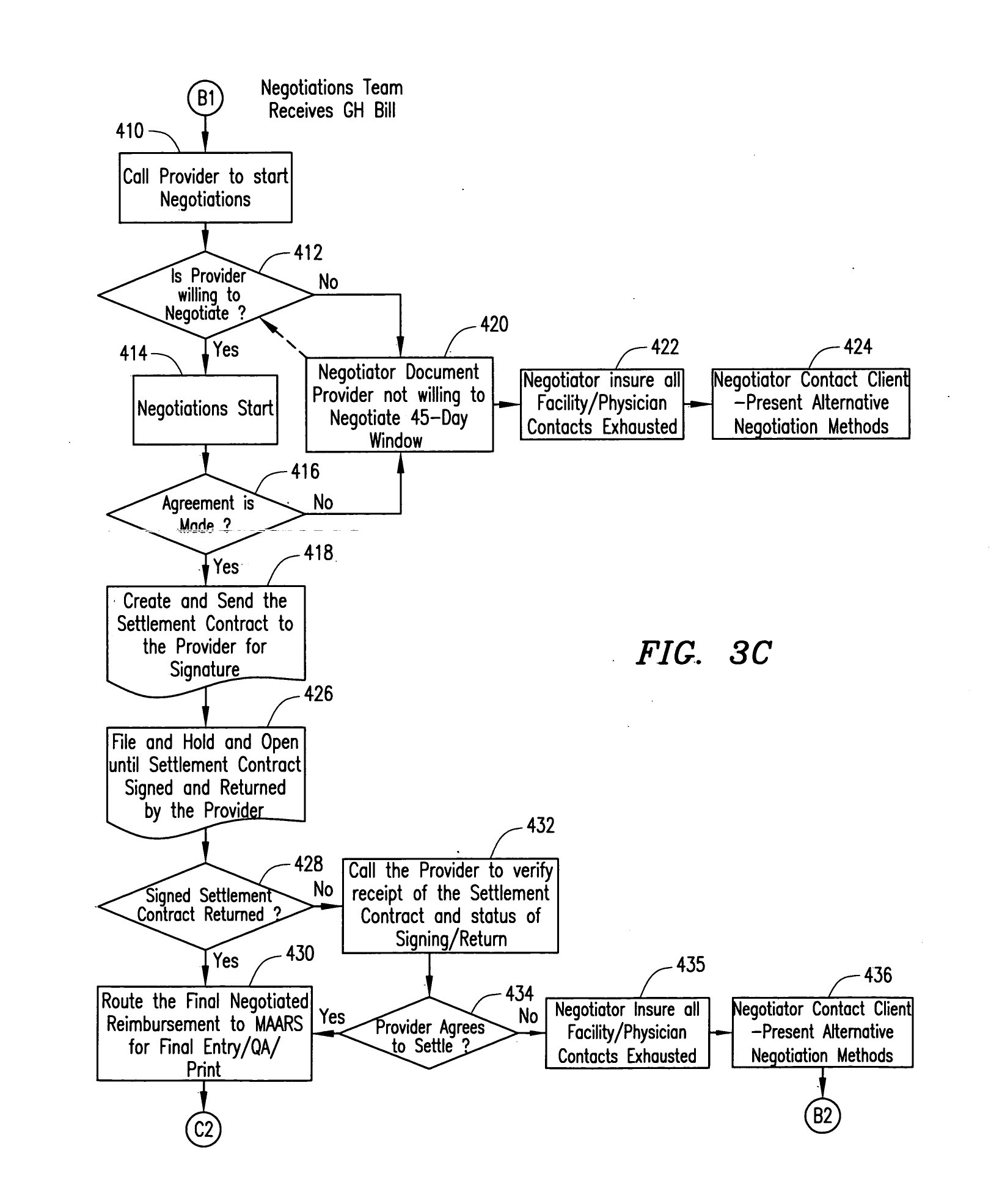

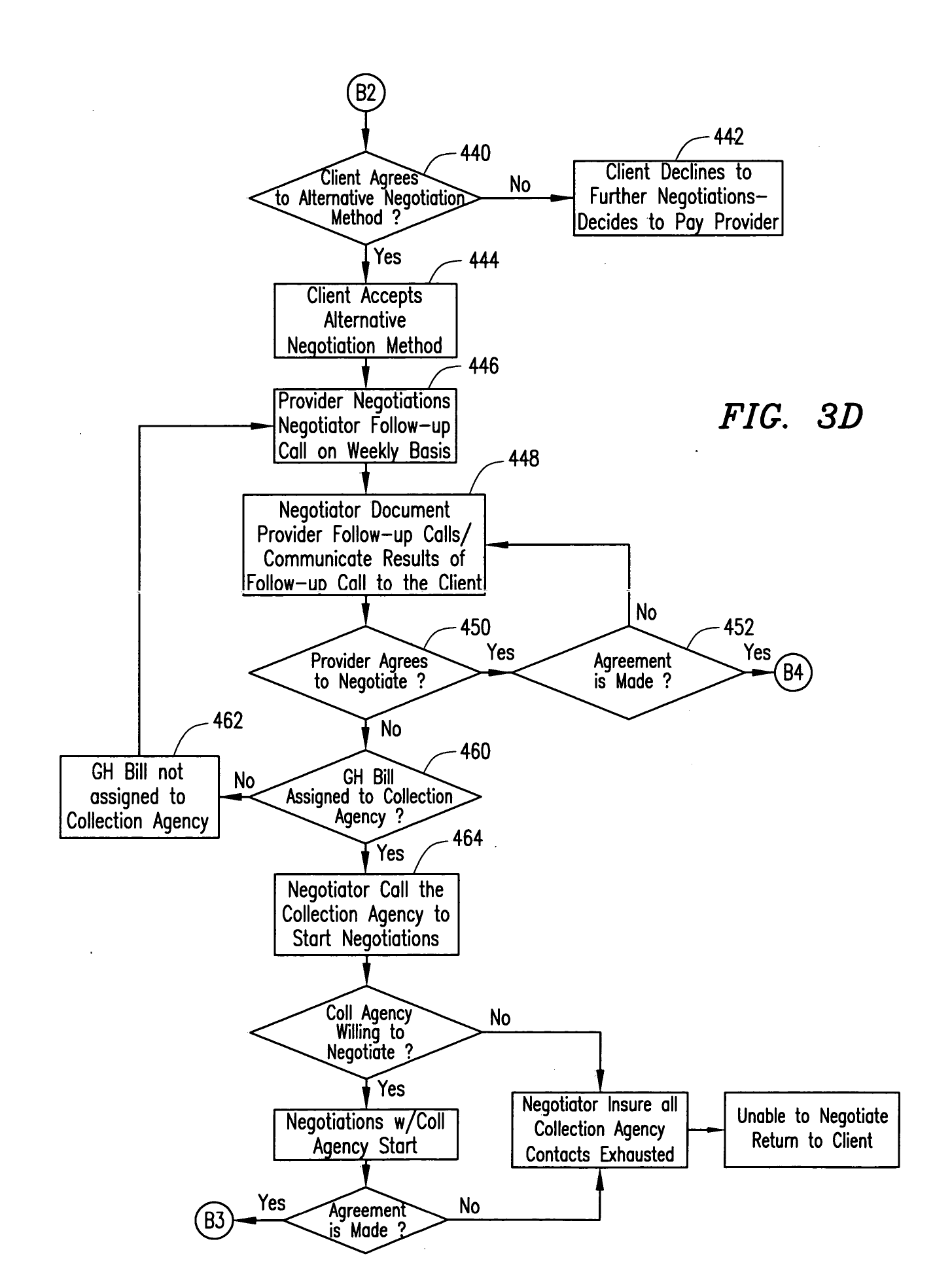

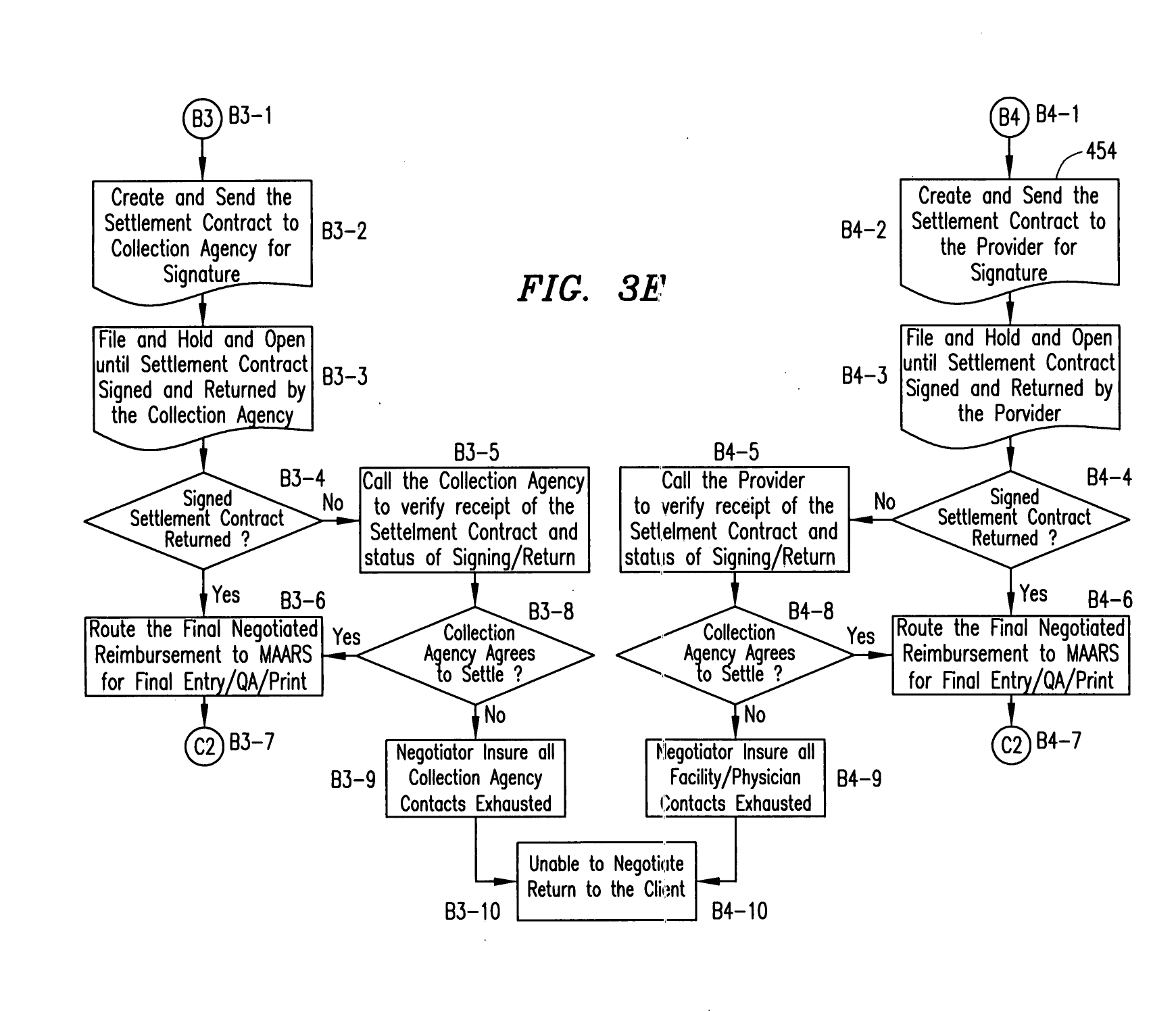

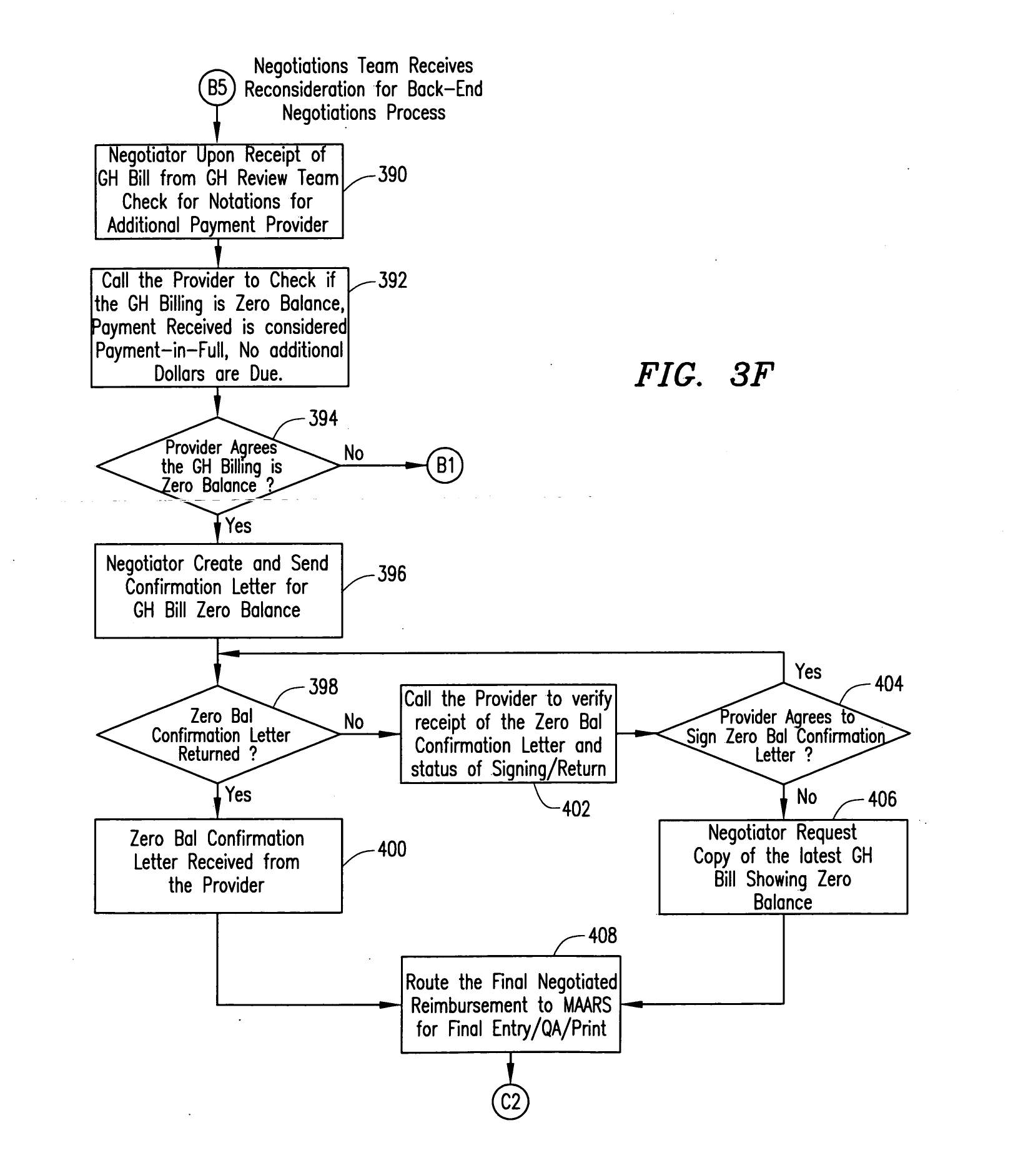

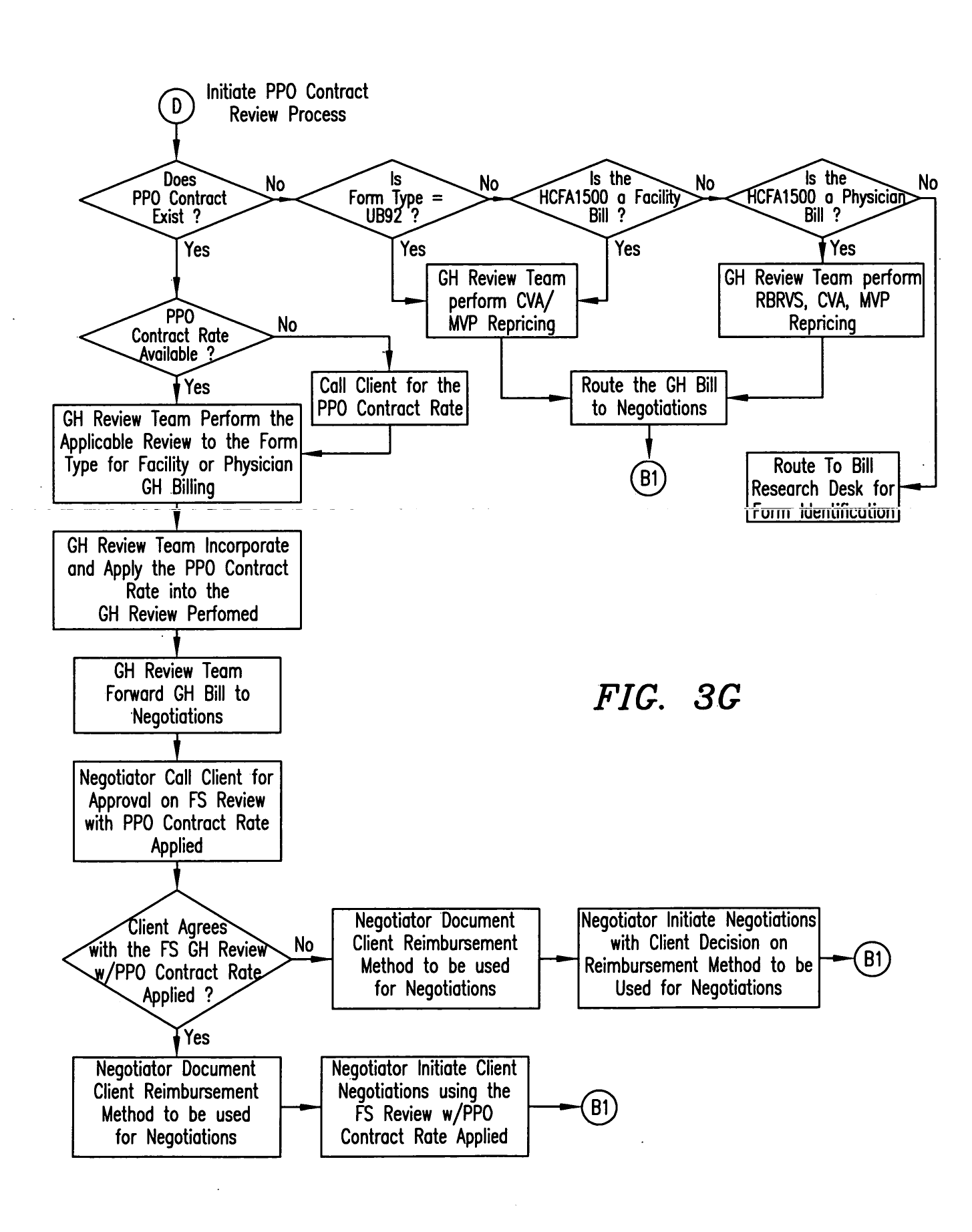

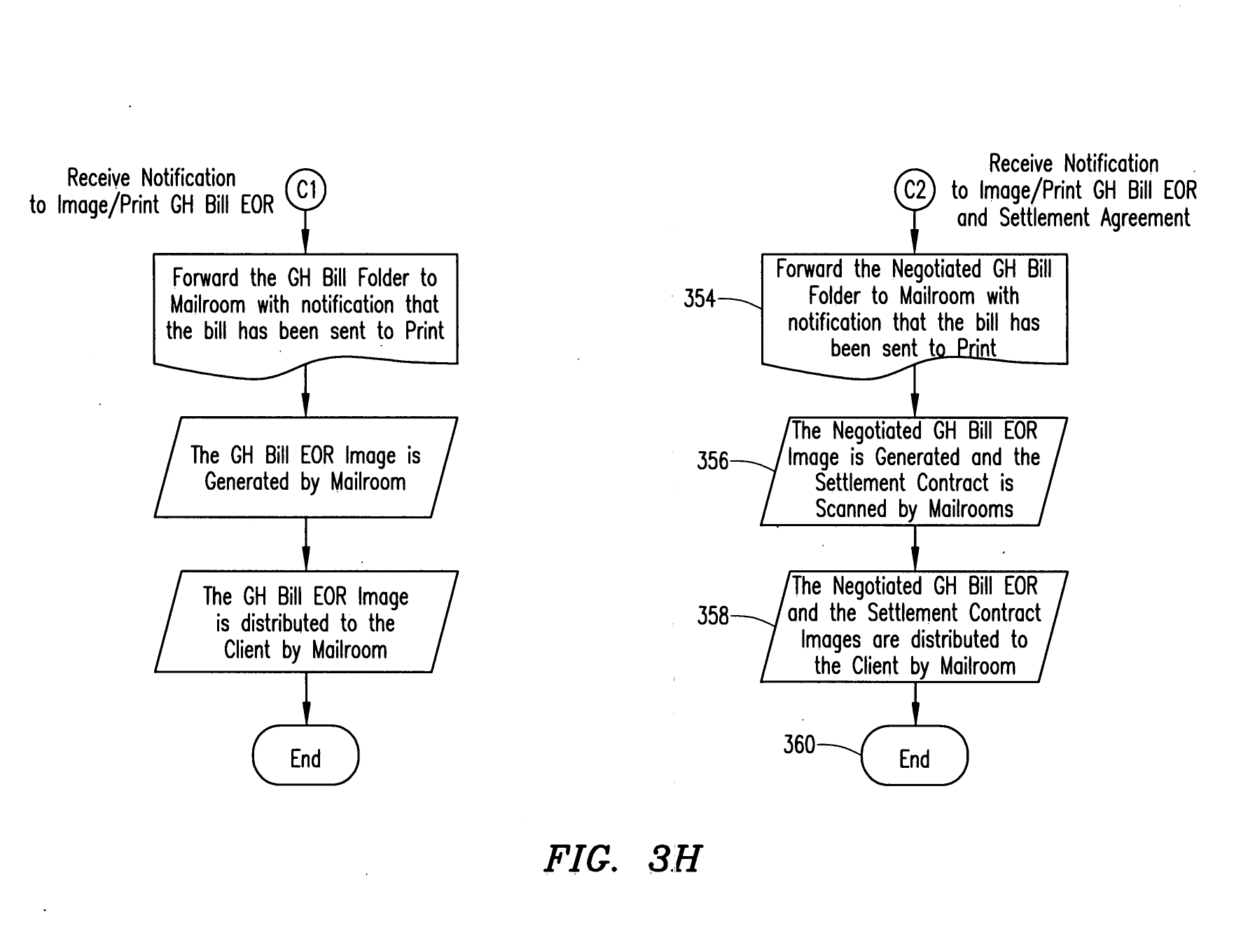

Referring now to FIGS. 3A-3H, an exemplary group health bill review negotiation workflow flow chart is provided. At step 300 a bill for medical services is received from a group health provider. At this point of a method in accordance with an embodiment of the present invention starts processing the service provider's medical bill. At step 302 it is determined whether the medical bill is a group health type medical bill. If it is not a group health medical bill, then it goes off to step 303, where the medical bill is reviewed by another exemplary method for reviewing the bills. For example, step 303 may be a method for reviewing a medical bill associated with a work-related injury or auto accident. If the medical bill is a general health type medical bill at 302, then at 304 it is determined whether the general health bill is a UB92 form type of a general health bill. A UB92 form medical health bill is the type of medical health bill that is normally provided by a hospital, ambulatory surgery center or a type of medical facility. If the bill form type is a UB92, then the medical bills came from some type of medical facility, and at box 306, the general health bill is entered into a system that suggests repricing of line elements on the group health bill. Such a repricing system may be a MAARS system. At step 306, the bill is entered into the repricing system.

At step 308 it is determined whether or not the group health bill is a duplicate bill. If the group health bill is determined to be a duplicate bill at step 310 the group health duplicate bill is returned to the third party payer (i.e., an insurance or medical insurance company who is responsible for paying for the medical services provided to a patient).

If the group health bill is not considered a duplicate at 308, then it is determined at step 312 whether the group health bill is a reconsideration bill. A reconsideration bill is a bill wherein a previous payment has already been made to the medical service provider for services rendered to a patient, but the medical service provider may be providing a reconsideration bill that requests a payment for additional services that were not on the originally paid medical bill or that requests that an additional payment be made for services that have already been either partially paid for or paid for in full. The reconsideration bill process is part of the back end portion of an exemplary embodiment of the present invention and will be discussed in more detail below.

At step 312, if the group health bill is not considered a reconsideration bill, then at step 316 the group health bill is routed to a first review at step 316. A first review may include personnel and/or software that uses a third or first party application to process hospital bills, ambulatory surgery bills, or any type of medical facility bill. In one embodiment of the first review, a repricing of the medical bill is performed via an application that asserts and applies billing fee rules established by Medicare. At step 318 the medical bill is then routed to a general health review team that first determines at step 320 whether or not a PPO contract applies to the particular group health medical bill. In some cases wherein a PPO contract covers the general health medical bill, a fixed discount percentage may be applied to the bill. Thus, if a PPO contract does apply to the bill, then at step 322 the appropriate discount is applied to the bill. At step 320 if no PPO contract applies to the received general health bill, then the bill moves to step 324 where the general health review team performs a charge validation analysis (CVA) and a market value pricing analysis on the individual line items on the bill in order to produce a suggested repricing of potentially each element within the bill. The general health review team will then provide an adjusted or suggested repriced bill amount that is routed to the general health bill negotiators at step 326.

Back at step 324, it is understood that the charge validation analysis is particularly applied to in-network bills in order to determine whether there have been any unbundling of charges, duplicate charges or whether there is sufficient documentation for the particular charge. For out of network bill, the market value pricing is another method that may be used in a MAARS type system which uses repricing data points. Such repricing data points may be based on any one or more of the data points that establish the average payment being accepted for the same services performed in the same or a similar geographic location, as well an unbundling charge, an incorrect CPT code, a charge that exceeds a predetermined percentage of a usual charge, a published medical billing guideline, or a statistical trend analysis result based on past, present and estimated future costs and payment for a medical product or service.

In FIG. 3B an exemplary front end negotiation method for repricing a general health bill is depicted. At step 326 the general health bill is routed to negotiators, who, at step 328 call the medical service provider to initiate potential negotiations. In general, the medical service provider is contacted as soon as feasible by the negotiator in order to get negotiations for potentially repricing the medical bill started. At step 330 it is determined, by the negotiator, whether or not the medical provider is willing to negotiate and potentially reprice the medical bill. If the medical provider is not willing to negotiate at step 330, then the negotiator, at step 332, documents that the medical service provider is not willing to negotiate on the medical bill. At step 334 the negotiator makes multiple contacts with the medical service provider to ensure that all the facility's and/or physician's contacts have been exhausted and are all equally unwilling to negotiate a repricing of the medical bill for the patient. At step 336 if the negotiator is convinced that there is no chance for a potential renegotiation of the medical bill, then the medical bill is returned to the third party payer for payment. Nonetheless, back at step 332, if the negotiator notes in his documentation and/or determines that there is a possibility that the medical service provider may be willing to negotiate a repricing of the medical bill, then a time period is waited before the negotiator recontacts the medical service provider. The time period waited is generally a predetermined amount of time ranging from about 7 days to about 120 days, but may be any range therein (i.e, 7 to 30 days). It is also understood that the amount of time to wait may extend beyond 120 days to six to nine months. In general though, the time period waited is about 5-10 days, but may be any time after about a 30 day window. After the time period has passed, the negotiator may recontact the medical service provider at step 330 and find that the medical service provider is willing to negotiate. At step 338 the negotiations may commence between the medical service provider and the negotiator. The negotiator may negotiate the various line items and specific data points uncovered by the general health review team at step 324.

If an agreement is not made at step 340, then the negotiator documents that the service provider is not willing to come to an agreement at step 332 and steps 334 and 336 are utilized. If an agreement is made at step 340, then at step 342 a settlement contract is created and provided to the service provider indicating that a settlement to a repriced bill has been made and agreed to by both parties. An exemplary settlement agreement generally states that the parties agree that the repriced amount would be accepted as full and final settlement of the allowed amount due for the service provider's billed charges. The exemplary settlement agreement further may require that the settlement agreement supersedes all other agreements between the parties and their agents as to monies due for the particular account for the medical services provided to the patient. The settlement agreement is considered a legal document that binds the parties. At step 344, the file is placed on hold while the settlement agreement is forwarded to the medical service provider and then returned with a signature from the medical service provider. At 346, if the medical service provider has not returned the signed settlement contract within a predetermined amount of time, then the service provider is contacted at step 348 to determine the status of the signing and return of the settlement agreement. At step 350, it is determined whether the service provider will agree to sign the settlement agreement and if they do, at 352 the signed settlement agreement is received and then entered into the repricing system's database for use as historic data. Furthermore, a final bill is suggested to be paid by the third party payer/service provider. At step 346, of course if the signed settlement agreement or contract is returned by the medical service provider, then at step 352 the negotiated repriced bill is then entered for historic data points into the repricing system or application for use in the future. The file for the group health bill is provided to the payer for payment via FIG. 3H, steps 354, 356, 358 and 360.

Moving back to FIG. 3A and step 304, if it is determined that the group health bill is not a UB92 form of billing (i.e., not for a hospital, emergency room or medical facility bill) then at step 362 it is determined whether the group health bill is in the form of an HCFA1500 bill. An HCFA1500 form bill is generally from a physician, some medical facilities, ambulance groups or medical specialists. If at 362 the general health medical bill is determined to not be in a UB92 format or an HCFA1500 format then at step 364 the medical bill is routed to a research desk in order to identify the type of medical bill that was received.

At step 362, if it is determined that the group health medical bill is a form HCFA1500 bill, then it is determined whether or not it is for a medical facility or from an individual medical service provider such as a physician at step 366. If it is from a medical facility, then the method goes to step 306 as discussed above. If at step 366 it is determined that the medical bill is not for a medical facility, then at step 368 it is determined whether or not the medical service bill is from a medical physician or physician group. If it is from a medical physician group then the bill is entered into the repricing system in step 370, which is similar to step 306 described above.

At step 372 it is determined whether the medical service health bill is a duplicate or not. If the medical service bill is a duplicate, it is returned to the client/payer as a duplicate at step 374. If it is determined that the medical services bill is not a duplicate then at step 376 it is determined whether or not the general health bill is one for reconsideration. If the general health bill is a reconsideration bill then it is routed to the general health review team reconsideration review at step 314.

On the other hand, if the general health bill is not a reconsideration bill, then the general health medical bill should be routed to the general health bill review team via a determination of whether or not the bill has a PPO contract that is applicable to it at step 380. The general health review team performs CVA and MVP repricing techniques on the bill. Furthermore, at step 382 RBRVS repricing is applied. RBRVS repricing is a resource based relative value scale repricing, which is basically a Medicare physician fee schedule used to aid in repricing medical bills originating from physician services. After an element-by-element repricing suggestion is established at step 382, the general health bill is routed to the general health medical bill negotiators at step 326 and continues as discussed above.

In the back end portion of an embodiment of the invention, the exemplary method in accordance with the present invention will now be described. In FIG. 3A starting at step 312 where the general health bill is determined to be a reconsideration bill it is then sent to step 314 where a general health review team for reconsideration bill review reviews the reconsideration bill from the medical service provider. The reconsideration bill is generally one from a medical service provider wherein the medical service provider is requesting additional reimbursement dollars for services rendered. The health bill review team for reconsideration bills reviews any documentation available from any prior related bills and notes any possible payment adjustments.

Referring now to FIG. 3F at step 390, the negotiator receives the general health reconsideration bill from the general health review team and checks for notations made by the reconsideration bill review team and any additional payments requested by the provider. Again, this is a back end portion of an exemplary method. The negotiator will note if there are any changes to the dollar amounts on any matching line items when comparing with the previously provided bill for the same or similar services and for the same patient. Furthermore, a medical service provider may have also submitted on the reconsideration bill additional line items that were not found on the original medical bill. In other circumstances the reconsideration bill may have been submitted because all of the necessary documentation had not been provided with the original bill and such additional documentation is being provided with the reconsideration bill.

At step 390 the negotiator receives the reconsideration bill along with notations on the individual line items provided by the reconsideration bill review team. At step 392, the negotiator contacts the medical service provider to determine if the original medical bill is considered to have a zero balance and whether this reconsideration bill was sent in error. In other words, the negotiator is checking to see if the medical service provider will accept the payment for the original bill and/or repriced bill as complete and final payment for services rendered to the patient thereby leaving a zero balance due. It is understood that since this is a reconsideration bill there was a previous payment made for medical services for the patient and thus, it is important that negotiators in accordance with the method of the present invention call the service provider to check and determine whether the balance due is considered zero or whether the fees or additional fees in the reconsideration bill are also due. At step 394, if the medical service provider agrees that the medical bill is at zero balance (i.e., no additional funds are owed), then at step 396 the negotiator creates and sends a confirmation letter to the medical service provider stating that it is agreed that the medical bill for the particular patient has been paid in full, or that the portion of the medical bill owed by the medical insurance company or other insurance company is paid in full, and any remaining fees are to be paid by the patient.

At step 398 it is determined whether the zero balance confirmation letter was returned from the medical service provider and signed thereby indicating that no additional monies are owed by the third party payer to the medical service provider for medical services rendered to the particular patient 400. If at step 398 the zero balance confirmation letter is not signed and returned from the medical service provider, then at step 402 the medical service provider is contacted to verify their receipt of the zero balance confirmation letter or document and the status of signing and returning that letter. If the provider agrees once again to sign the zero balance confirmation letter at step 404, then the method moves on to step 398. But if the service provider declines to sign and return the zero balance confirmation letter then at step 406 the negotiator will request the latest copy of the paid medical bill indicating that there is a zero balance. This is possible because the negotiator has already agreed that there is a zero balance on the medical bill that was pending and that the reconsideration bill was either sent in error or is not necessary to be paid in full. At step 408 the final negotiated reimbursement is entered into the repricing application software or the repricing system and a final entry is made into the system, quality assurance is passed and a printing of the negotiated price is created.

The method then moves to FIG. 3H where the negotiated final bill is sent to the mail room and printed at step 354 and the agreed on settlement contract and/or final zero balance letter, or zero balance bill is scanned and images of the same are distributed to the payer with instructions to either pay some additional amount or that a zero balance has been settled at step 358.

Still referring to FIG. 3F, at step 394, if the medical service provider does not agree that there is a zero balance for the medical bill then the method proceeds to FIG. 3C.

At FIG. 3C the negotiator calls the medical service provider at step 410 to attempt to start negotiations with respect to the reconsideration bill. At step 412 it is determined whether the medical service provider is willing to negotiate the reconsideration bill. If the medical service provider is willing to negotiate the reconsideration bill, the negotiations start at step 414. If an agreement is made at step 416, then the negotiator, at step 418 creates and sends a settlement contract to the service provider for signature. The settlement contract is substantially similar to the settlement contract discussed at step 342 above.

Referring back to step 412, if the medical service provider is unwilling to negotiate, the negotiator, at step 420, documents that the service provider is unwilling to negotiate and waits a predetermined amount of time before attempting to renegotiate the reconsideration bill with the medical service provider. The predetermined amount of time may be any amount of time from about 30 days to about 120 days. It is also understood that the predetermined amount of time may be longer than 120 days and equal from three to nine months or more. It is also understood that the predetermined amount of time for waiting to attempt to renegotiate with the medical service provider with respect to the reconsideration bill may be to a point in time near the end of a fiscal billing period or the end of the year for the medical service provider wherein the medical service provider may be more incentivized to renegotiate the reconsideration bill. It is further understood that at this point in time the service provider has already received payment for the medical bill or repriced medical bill and is potentially asking for additional payment on the repriced medical bill. Furthermore, at step 422 the negotiator may contact additional entities within the medical service provider's organization. Such other entities may be the CFO, the billing administrator, other accounts payable employees, etc. If all contacts are exhausted at the medical service provider, then at step 424 the negotiator contacts the third party payer and presents potential or possible alternative negotiation methods for decreasing the payment of the reconsideration bill.

Before going on to discuss alternative negotiation methods from step 422, let's return to step 418, wherein a settlement contract was provided to the medical service provider for signature. At step 426, the file is put on hold until the settlement contract is signed and returned by the medical service provider. At step 428 if the signed settlement contract is returned then it is routed the final negotiated reimbursement numbers for entry into the MAARS system for historic data, quality assurance and the printing of the final agreement is performed. The method then would proceed to FIG. 3H and steps 354, 356, 358 and 360 as discussed hereinabove.

If at step 328 the signed settlement contract is not returned and the medical service provider is contacted at step 432 and still refuses to settle the reconsideration bill at step 434, then the negotiator will make note that he has exhausted various possible contacts at the medical service provider at step 435 in a similar fashion as the above explained step 422. The negotiator will contact the client/payer and present potential alternative negotiation methods at step 436.

Referring now to both steps 424 and 436 where a negotiator has contacted a third party payer/client, we look at FIG. 3D and determine, at step 440, whether the payer would agree to an alternative negotiation method. At step 442, if the payer is not interested in further negotiations or alternative negotiation methods, then the payer may decide to go ahead and pay the medical provider the reconsidered amount without using the repriced recommended amount. If, on the other hand, the payer is interested in looking into an alternative negotiation method in order to decrease the potential payment to the medical service provider at step 440, then the payer may accept an alternative negotiation method at step 444. At step 446 the negotiator contacts the medical service provider, in accordance with an embodiment of the present invention, on substantially a weekly or periodic basis in order to attempt to get the medical service provider to become interested in negotiating the reconsideration bill. At step 448, the negotiator documents all the medical service provider follow-up calls and contacts and communicates the results of such calls and contacts to the third party payer. If the medical service provider agrees to negotiate or open negotiations at step 450, then an agreement may be made at step 452 wherein the reconsideration bill is either cancelled or repriced to a lower “owed” amount. At that point, the exemplary method moves to FIG. 3E and the negotiator creates a settlement contract at step 454. After step 454, this back end portion of the exemplary embodiment of the present invention is very similar to the back end portion of the exemplary embodiment discussed above with respect to FIG. 3C starting at step 418 and/or FIG. 3B starting at step 342.

If at step 450 the medical service provider does not agree to negotiate then at step 460 the reconsideration bill may be assigned to a collection agency upon approval from the payer. If the payer is not interested in assigning the reconsideration bill to a collection agency at 462, then the medical service provider may be once again contacted on a weekly basis in order to attempt to initiate another chance to negotiate the reconsideration bill.

If at step 460 the payer agrees to wait for the reconsideration bill to be assigned to a collection agency, then at step 464 the negotiator contacts a collection agency to start negotiations with the medical service provider to potentially decrease the balance owed to the medical service provider for the reconsideration bill.

With respect to FIG. 3G, this figure refers to initiation of a PPO contract review process from FIG. 3A, steps 320 or 380 wherein a PPO contract is available and governs the payment of the medical service provider bill.

It is important to understand that embodiments of the present invention and method provide a repricing technique for a MAARS system or similar system that identifies data points which can be used as a starting point for negotiating particular line items on a medical bill or reconsideration bill by the negotiator. It is understood that there are a number of companies in the industry that do negotiate and renegotiate medical service bills, but generally they look for a simplified result of a 5%, or 10% off the billed charges. Embodiments of the present method are not simply looking for 5-10% off of charges, but take the itemized medical services on the provider's bills to a more detailed review and level so that itemized charges can be negotiated rather than the entire bill being discounted by a negotiated percentage. In other words, a more detailed and comprehensive review of each item on the bill may be compared to what Medicare would normally pay or what Blue Cross or Blue Shield would normally pay, or to what the particular service provider has requested for the same services in the past can be used as a negotiation tactic for lowering the specific itemized medical charges on the medical bill. Furthermore, the medical service provider's actual costs may be utilized as a negotiation tool for the specific itemized charges. The negotiator may be provided the medical service provider's actual cost and have a higher degree of knowledge about the costs of certain medical services or supplies prior to going into negotiation and thereby more successfully present their arguments for lowering and/or adjusting the bill in favor of the payer or agent for the payer. Embodiments of the present method also filter out invalid and unsubstantiated charges when the medical service provider submits only general billing information lieu of detailed itemized charges. The negotiation tools on payment information, charge information and cost information applies to the general billing information in the same method as applies to the itemized charges.

Furthermore, it is important to note that in methods in accordance with embodiments of the present invention, the creation of sign off documents, such as the settlement contracts or zero balance letters, for signature by the medical service provider once an agreement to the repriced bill amount is reached is an important element to some embodiments of the present method. A payment of the repriced medical bill or reconsideration bill is not made until a settlement agreement or zero balance letter is signed and returned by the medical service provider. This aids in limiting additional liability and possible lawsuits on or against the third party who is paying for the patient's medical services. It also may protect the patient from additional charges.

The settlement agreement contract and/or the zero balance confirmation letter are created immediately after agreement has been reached between the medical service provider and negotiator about the particular medical bill in question. By creating such confirmation letters and getting them to the medical service provider immediately after agreement, agreements are confirmed and the transaction is completed generally in a more timely fashion because the negotiations and settlement are fresh on both parties' minds. Having signed settlement agreements and zero balance confirmation letters help to alleviate concerns of additional costs and potential litigation for the payer/medical insurance companies. In essence, embodiments of the present method help to provide a check and balance system to bills from medical service providers such that fair value or fair payment is being rendered for the medical services being provided by the medical service providers.

Each finalized negotiation provides additional data points, which are saved and stored within the repricing application or MAARS type system for use in the future and historic data indicating what a particular medical service provider agreed to discounted charges for particular services and further provides additional statistical data for geographic costs for the same medical services.

It is further understood that various embodiments of the MAARS or other exemplary repricing system may use data about the costs for medical services and supplies generated from a variety of sources including, but not limited to, accounting firm data based on publicized costs for medical services rendered, data related to average managed care reimbursement for medical services rendered on a national or localized geographic basis, a hospital's cost to charge ratio for services rendered, the data associated with average Medicare reimbursement for both medical facilities and physician medical services and other medical service related cost and payment data from publicly available databases.

When the medical bill review team performs CVA and MVP repricing on a medical bill or reconsideration medical bill, they provide detailed documentation in the form of a report or data file to the negotiators discussing items that arguably could be reduced in price on the medical bill. Such information is very valuable to the negotiators when negotiating a repricing of a medical service bill or reconsideration bill with a medical service provider. For example, if a charge for a particular surgery performed in a medical facility or by a particular medical service provider exceeds a set percentile for such medical services in a particular geographical area, the negotiator would be informed of such and attempt to negotiate that fee down to a more reasonable price given the particular medical services facility and the geographical location thereof. The negotiator may be able to negotiate the reimbursed price based on fees that were reviewed and compared to a standard of reasonableness based on comparisons with industry benchmarks for costs, payments, and charges for comparable services and reimbursements therefor in a comparable service area as well.

It is understandable for those who are skilled in the art that the method of medical bill review and negotiation for the front end as well as the back end process of exemplary embodiments of the present invention provide various methods and techniques for aiding and controlling overcharges or up-charges for medical services being provided.

Although preferred embodiment(s) of the method and business technique of embodiments of the present invention have been illustrated in the accompanying Drawings and described in the foregoing Detailed Description, it is understood that the present invention is not limited to the embodiment(s) disclosed, but is capable of numerous rearrangements, modifications, and substitutions without departing from the spirit of the invention as set forth and defined by the following claims.

What is claimed is:

1. A method for finalizing an agreement for payment of medical services, said method comprising:
repricing a medical bill from a service provider;
establishing a repriced amount for said medical bill; and
recommending that a payer pay said service provider said repriced amount;
waiting a first predetermined amount of time after the payer has paid the repriced amount and then contacting said service provider to determine whether said service provider accepts said repriced amount as complete payment for said medical bill;
if said service provider accepts said repriced amount as a complete payment for said medical bill then providing at least one of a settlement contract and a zero balance confirmation letter to said service provider for signature;
if said service provider does not accept said repriced amount as a complete payment for said medical bill then negotiating a settlement amount based on at least one specifically identified data point determined during repricing of said medical bill.

2. The method of claim 1, wherein said first predetermined amount of time is between 30 and 120 days.

3. The method of claim 1, wherein repricing comprises:
determining legal and regulatory requirements that apply to said medical bill;
analyzing said medical bill based on the determined legal and regulatory requirements;
determining at least one of erroneous charges, and an actual cost of services on said medical bill; and
providing a repricing recommendation.

4. The method of claim 1, wherein said medical bill is a reconsideration medical bill.

5. The method of claim 1, wherein said at least one specifically identified data point is based on at least one of an unbundling charge, an incorrect CPT code, a charge exceeding a usual payment for services in an associated geographical location, a published medical billing guideline, and a statistical trend analysis result.

6. The method of claim 1, wherein after negotiating a settlement amount, further comprising:
providing at least one of a settlement contract and a zero balance confirmation letter to said service provider for signature if negotiation of said settlement agreement is successful; and
waiting a second predetermined amount of time after negotiating and then contacting said service provider to determine whether said service provider accepts said repriced amount as complete payment for said medical bill.

7. The method of claim 1, wherein after repricing said medical bill, further comprising contacting said service provider and negotiating said repriced amount.

8. A method of establishing a payment amount for a medical service provider, said method comprising:
receiving a medical service provider's bill;
performing front-end negotiations and determining a repriced bill;
having said repriced bill paid;
performing back-end negotiations comprising:
contacting said service provider after said repriced bill has been paid and making a first request that said service provider agree to at least one of signing a zero balance confirmation letter and of negotiating said repriced bill;
negotiating, if said service provider agrees to negotiating said repriced bill, said repriced bill to an agreed settlement amount and providing a settlement letter to said service provider;
waiting a predetermined amount of time, if said service provider does not agree to signing said zero balance confirmation letter and does not agree to negotiating said repriced bill, then recontacting said service provider and making a second request that said service provider agree to at least one of signing a zero balance confirmation letter and to negotiating said repriced bill.

9. The method of claim 8, wherein said service provider is one of a medical facility and a medical professional.

10. The method of claim 8, wherein said reconsideration bill requests additional payment for at least one of medical services and medical supplies on said service provider's bill.

11. The method of claim 8, wherein said repriced bill requests payment for at least one of additional medical services and additional medical supplies related to said service provider's bill.

12. The method of claim 8, further comprising providing a zero balance confirmation letter to said medical service provider for signature by said medical service provider after making said first request.

13. The method of claim 8, wherein said front-end negotiations comprise: repricing said medical service provider's bill by a repricing means.

14. The method of claim 8, wherein said front-end negotiations comprise:
repricing said medical service provider's bill using a repricing method into said repriced bill;
contacting said medical service provider to determine whether said medical service provider will negotiate said medical service provider's bill,
negotiating said repriced bill with said medical service provider if said medical service provider will negotiate; and
waiting a predetermined amount of time to recontact said service provider if said service provider will not negotiate said repriced bill.

15. The method of claim 14, wherein said repricing method comprises forecasting future and present day medical service provider costs based on collected past, present and historical medical cost and reduced payment information.

16. A method of finalizing a negotiated medical bill payment comprising:
providing, to a medical service provider, a first settlement document prior to paying a negotiated repriced bill to said medical service provider;
receiving, from said medical service provider, a reconsideration bill related to said repriced bill;
reviewing data associated with said negotiated repriced bill;
contacting said medical service provider to determine if said medical service provider will at least one of agree that a zero balance is owed for said reconsideration bill and agree to negotiate said reconsideration bill;
if said medical service provider agrees that a zero balance is owed, then providing a zero balance confirmation letter to said medical service provider;
if said medical service provider will not negotiate said reconsideration bill, then waiting a predetermined amount of time and then contacting said medical service provider again to determine if said medical service provider will negotiate said reconsideration bill;
if said medical service provider will negotiate said reconsideration bill, then negotiating said reconsideration bill using at least one data point associated with a reconsideration bill charge item and then establishing a negotiated reconsideration bill;
providing, to said medical service provider, a second settlement document prior to having said negotiated reconsideration bill paid.

17. The method of claim 16, wherein said medical service provider signs and returns said first settlement document prior to having said negotiated repriced bill paid.

18. The method of claim 16, wherein said medical service provider signs and returns said second settlement document prior to having said negotiated reconsideration bill paid.

19. The method of claim 16, wherein said medical service provider signs and returns said zero balance confirmation letter.

20. The method of claim 16, wherein said predetermined amount of time is 30 to 120 days.
